(19) United States
(12) Patent Application Publication
(10) Pub. No.: US 2026/0081134 A1
(43) Pub. Date: Mar. 19, 2026

(54) ELECTRODE SHEET MANUFACTURING APPARATUS AND METHOD FOR MANUFACTURING ELECTRODE SHEET

(71) Applicant: SAMSUNG SDI CO., LTD., Yongin-Si (KR)

(72) Inventor: YOHAN JEONG, Yongin-Si (KR)

(21) Appl. No.: 19/185,715

(22) Filed: Apr. 22, 2025

(30) Foreign Application Priority Data
Sep. 13, 2024 (KR) 10-2024-0126132

(51) Int. Cl. H01M 4/04

(52) U.S. Cl. CPC H01M 4/043; H01M 4/0404; H01M 4/0471

(57) ABSTRACT

An electrode sheet manufacturing apparatus and a method for manufacturing an electrode sheet include a coating portion configured to apply an electrode slurry on a base material to form a coating layer, an attachment portion configured to attach a tape to the base material in a region where the coating layer is not formed, a pressing portion configured to press the coating layer and/or the tape, and a removal portion configured to remove the tape from the base material.

### CROSS-REFERENCE TO RELATED APPLICATION

The present application claims priority to and the benefit under 35 U.S.C § 119(a)-(d) of Korean Application No. 10-2024-0126132, filed in the Korean Intellectual Property Office on Sep. 13, 2024, the entire disclosure of which is incorporated herein by reference.

### BACKGROUND

### 1. Field

The present disclosure relates to an electrode sheet manufacturing apparatus and a method for manufacturing the electrode sheet. More specifically, the present disclosure relates to an electrode sheet manufacturing apparatus and a method for manufacturing the electrode sheet capable of improving processing efficiency and improving quality.

### 2. Description of the Related Art

While primary batteries are not designed to be (re)charged, secondary (also known as rechargeable) batteries are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly. An electrode sheet may be wound or stacked to form an electrode assembly and may be generally manufactured by applying an electrode slurry onto a base material such as an aluminum foil, a copper foil, etc.

The information disclosed in this Background section is for enhancement of understanding of the background of the present disclosure. The section may contain information that does not constitute related (or prior) art.

### SUMMARY

Embodiments of the present disclosure provide an electrode sheet manufacturing apparatus and method capable of applying even pressure to an entire area of a coating layer during a pressing process, by attaching a tape to a region of a base material, on which the coating layer is not formed.

Embodiments of the present disclosure provide an electrode sheet manufacturing apparatus and method capable of easily removing a tape from a base material only by supplying a heat source.

According to an aspect of the present disclosure, an electrode sheet manufacturing apparatus includes a coating portion forming a coating layer by applying an electrode slurry onto a base material, an attachment portion attaching a tape to a region other than the coating layer, above the base material, a pressing portion pressing the coating layer and the tape, and a removal portion removing the tape from the base material.

Embodiments of the present disclosure provide an electrode sheet manufacturing apparatus including: a coating portion configured to apply an electrode slurry on a base material to form a coating layer; an attachment portion downstream of the coating portion, the attachment portion configured to attach a tape to the base material in a region where the coating layer is not formed; a pressing portion downstream of the attachment portion, the pressing portion configured to press the coating layer and/or the tape; and a removal portion downstream of the pressing portion, the removal portion configured to remove the tape from the base material.

In an embodiment, the apparatus may further include a transport portion transporting the base material in a preset direction.

In an embodiment, the coating portion may include an application portion arranged to be spaced apart from the base material and applying the electrode slurry onto the base material, and a drying portion supplying a heat source onto the base material that passes through the application portion.

In an embodiment, the coating portion includes: an application portion spaced apart from the base material and configured to apply the electrode slurry; and a drying portion downstream of the application portion configured to supply heat to the base material.

In an embodiment, the attachment portion may include an attachment body attaching the tape onto the base material, a sensor unit sensing whether there is the coating layer along a center axis in a lengthwise preset direction, and a controller receiving information, from the sensor unit, about whether there is the coating layer and controlling driving of the attachment body.

In an embodiment, the attachment portion includes: an attachment body attaching the tape to the base material; a sensor unit configured to sense presence of the coating layer; and a controller configured to receive information from the sensor unit and configured to control the attachment body.

In an embodiment, the tape may include an attachment layer arranged to face the base material and being attachable to the base material, and a film layer connected to a surface of the attachment layer, which is opposite to one surface facing the base material.

In an embodiment, the tape includes: an attachment layer configured to be attached to the base material; and a film layer in contact with the attachment layer.

In an embodiment, the attachment layer may have a volume that may vary depending on a temperature.

In an embodiment, the attachment layer is expandable based on temperature.

In an embodiment, the film layer may include a thermosetting resin.

In an embodiment, the pressing portion may include a pressing roller that is capable of coming into contact with the base material in a thickness direction of the base material.

In an embodiment, the pressing portion includes a pressing roller configured to press the base material in a direction parallel to a surface of the base material.

In an embodiment, the removal portion may include a heater housing through which the base material to which the tape is attached passes, and a heater body that is installed in the heater housing and supplies a heat source to the tape passing through the heater housing.

In an embodiment, the removal portion includes: a heater housing configured to pass through the base material; and a heater body positioned in the heater housing and configured to supply heat to the tape.

In an embodiment, the heater housing may have a hollow inside, and may have an inlet portion through which the base material is introduced in one side thereof and an outlet portion through which the base material is discharged after passing through the inlet port in other side opposite to the one side.

In an embodiment, the heater housing has a hollow structure and has an inlet portion and an outlet portion.

According to an aspect of the present disclosure, an electrode sheet manufacturing method includes forming a coating layer by applying an electrode slurry on a base material, attaching a tape to a region other than the coating layer, above the base material, pressing the coating layer and the tape, and removing the tape from the base material.

Embodiments of the present disclosure provide a method for manufacturing an electrode sheet including: applying an electrode slurry on a base material to form a coating layer; attaching a tape to the base material in a region where the coating layer is not formed; pressing the coating layer and/or the tape; and removing the tape from the base material.

In an embodiment, the forming of the coating layer may include applying the electrode slurry on a preset region of the base material; and drying the applied electrode slurry.

In an embodiment, the applying includes: applying the electrode slurry on a preset region of the base material; and drying the electrode slurry.

In an embodiment, the attaching of the tape may include sensing whether there is the coating layer on the base material, and attaching the tape to a region where the coating layer is not formed.

In an embodiment, the attaching includes: sensing presence of the coating layer; and attaching the tape to the region where the coating layer is not formed.

In an embodiment, a thickness of the tape may be 50% to 120% of a thickness of the coating layer.

In an embodiment, the tape may include an attachment layer arranged to face the base material and being attachable to the base material, and a film layer connected to a surface of the attachment layer, which is opposite to one surface facing the base material.

In an embodiment, the tape includes: an attachment layer configured to be attached to the base material; and a film layer in contact with the attachment layer.

In an embodiment, the attachment layer may have a volume that may vary depending on a temperature.

In an embodiment, the attachment layer is expandable based on temperature.

In an embodiment, the film layer may include a thermosetting resin.

In an embodiment, the pressing includes: pressing the base material in a direction parallel to a surface of the base material.

In an embodiment, the pressing of the coating layer and the tape may include pressing the coating layer and the tape disposed on the base material by providing an external force in a thickness direction of the base material.

In an embodiment,

[symbol]

In an embodiment, the removing of the tape from the base material may include isolating the tape from the base material by supplying a heat source to the tape.

In an embodiment, the removing includes applying heat to the tape.

In an embodiment, the electrode sheet manufacturing method of may further include cutting the base material at preset intervals along a lengthwise direction.

In an embodiment, the method further includes cutting the base material at preset intervals along a longitudinal direction.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic diagram showing an electrode sheet manufacturing apparatus according to embodiments of the present disclosure;

FIG. 2 shows a coating layer formed on a base material according to embodiments of the present disclosure;

FIG. 3 is a block diagram showing an attachment portion according to embodiments of the present disclosure;

FIG. 4 shows a tape attached to a base material on which a coating layer is formed according to embodiments of the present disclosure;

FIG. 5 is a front view of FIG. 4 according to embodiments of the present disclosure;

FIG. 6 is an enlarged view of part C in FIG. 5 according to embodiments of the present disclosure;

FIG. 7 is an enlarged view of part A in FIG. 1 according to embodiments of the present disclosure;

FIG. 8 is an enlarged view of part B in FIG. 1 according to embodiments of the present disclosure;

FIG. 9 is a flowchart showing an electrode sheet manufacturing method according to embodiments of the present disclosure;

FIG. 10 is a flowchart certain processes in FIG. 9 in detail according to embodiments of the present disclosure; and

FIG. 11 is a flowchart illustrating certain processes of FIG. 9 in detail according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

The embodiments described herein can be explained with reference to cross-sectional views and/or plain views as example views of the present disclosure. In the drawing, the thicknesses of films and regions can be exaggerated for effective description of technical contents. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof. Like reference numerals refer to like elements throughout the specification.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

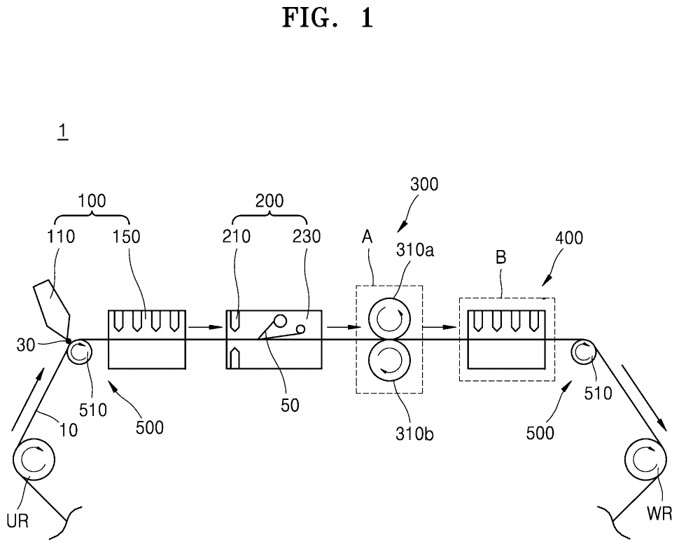

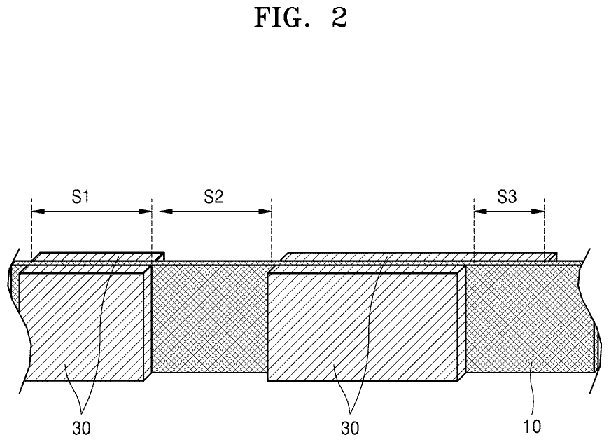

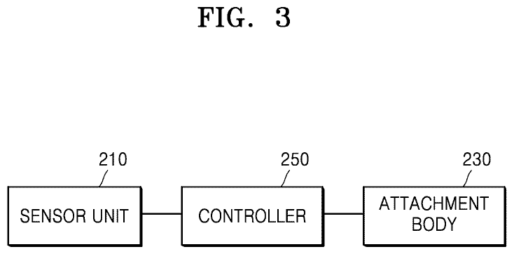

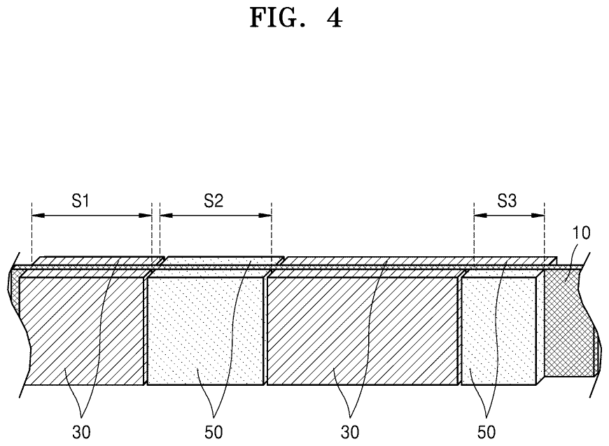

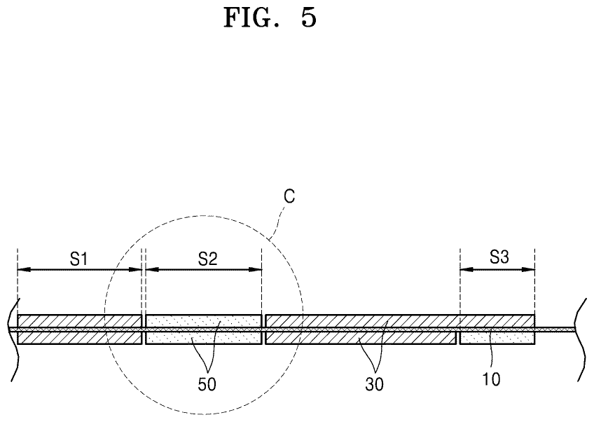

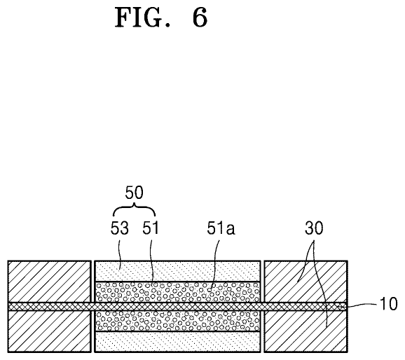

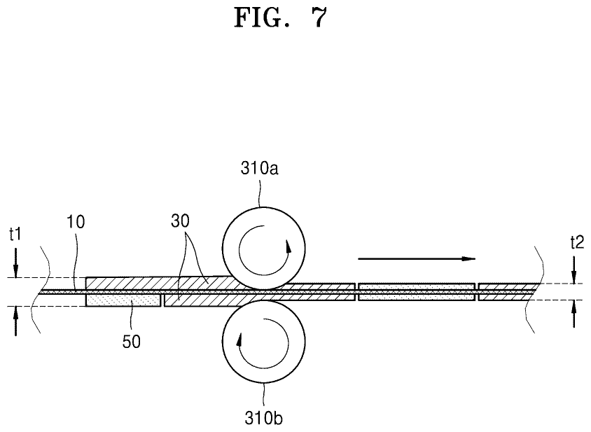

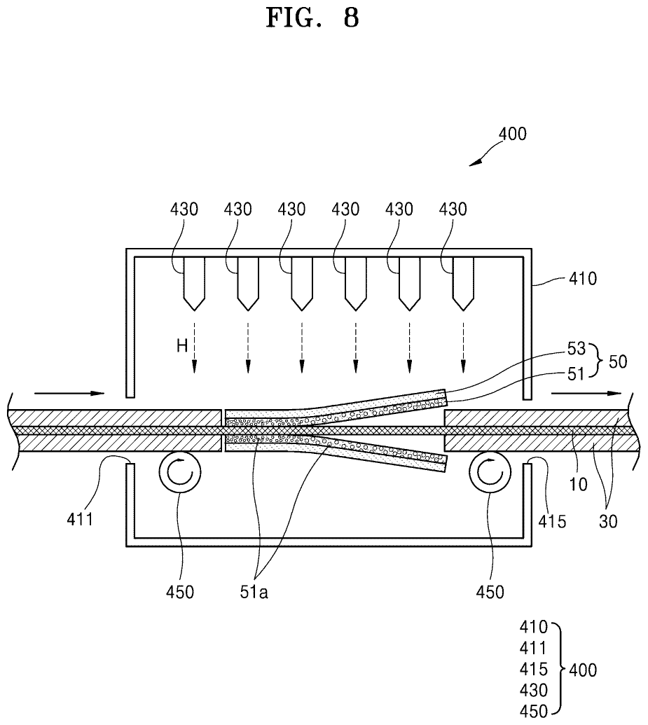

FIG. 1 is a schematic diagram showing an electrode sheet manufacturing apparatus 1 according to embodiments of the present disclosure. FIG. 2 shows a coating layer formed on a base material according to embodiments of the present disclosure. FIG. 3 is a block diagram showing an attachment portion according to embodiments of the present disclosure. FIG. 4 shows a tape attached to a base material on which a coating layer is formed according to embodiments of the present disclosure. FIG. 5 is a front view of FIG. 4 according to embodiments of the present disclosure. FIG. 6 is an enlarged view of part C in FIG. 5 according to embodiments of the present disclosure. FIG. 7 is an enlarged view of part A in FIG. 1 according to embodiments of the present disclosure. FIG. 8 is an enlarged view of part B in FIG. 1 according to embodiments of the present disclosure.

Referring to FIG. 1, an electrode sheet manufacturing apparatus 1 may include a device for manufacturing electrodes used in secondary batteries such as lithium-ion batteries. The electrode sheet may include a cathode sheet forming a cathode of a secondary battery or an anode sheet forming an anode of the secondary battery.

In an embodiment, the electrode sheet may be used as an electrode in a battery such as a lithium-ion battery and formed by applying an electrode slurry on a base material 10. Also, the electrode sheet may participate in an electrochemical reaction of a battery to store and discharge energy.

In an embodiment, the base material 10 may be coated with the electrode slurry. Typically, an aluminum foil may be used for manufacturing the cathode sheet and a copper foil may be used for manufacturing the anode sheet, but the present disclosure is not limited thereto. Various materials such as a copper film, a nickel film, a stainless-steel film, a titanium film, a nickel foam, a copper foam, a polymer can be used as the base material 10, which can be coated with conductive metal, etc.

In an embodiment, the electrode slurry includes a material used to manufacture an electrode sheet, and may include an active material, a binder, an electrical conductor, a solvent, etc.

The electrode sheet manufacturing apparatus 1 may include an unwinding portion UR, a winding portion WR, a coating portion 100, an attachment portion 200, a pressing portion 300, a removal portion 400, and a transport portion 500.

Referring to FIG. 1, the unwinding portion UR may unwind the base material 10 from a roll and may allow the base material 10 to be unwound at a constant speed and tension, and supplied to the coating portion 100. The base material 10 discharged from the unwinding portion UR may be transported in a transport direction (right hand side in FIG. 1) and may be used to manufacture an electrode sheet.

In some embodiments, the winding portion WR may wind the processed electrode sheet in a roll type to store the electrode sheet. Similar to the unwinding portion UR, the winding portion WR may allow the electrode sheet to be wound while maintaining a constant speed and tension to prevent damage to the electrode sheet.

Referring to FIGS. 1, 2, and 4 to 6, the coating portion 100 may form a coating layer 30 by applying the electrode slurry onto the base material 10 and may include an application portion 110 and a drying portion 150.

Referring to FIG. 1, the application portion 110 may be spaced apart from the base material 10 to apply the electrode slurry onto the base material 10 and may be fixedly installed above one surface of the base material 10 (e.g., upper side in FIG. 1) so as to be spaced apart a preset distance from the base material 10.

The application portion 110 may include a slot die having a long slot-shaped nozzle for evenly applying the electrode slurry. However, the present disclosure is not limited thereto. The application portion 110 may include a roller, a spray, a brush, etc.

Referring to FIG. 2, the electrode slurry applied on the base material 10 may form the coating layer 30. The coating layer 30 may be formed at a predetermined thickness and a certain pattern may be formed on the base material 10 depending on the type of application.

In an embodiment, one or both surfaces of the base material 10 may include a region where the coating layer 30 is formed and may include a region where the coating layer 30 is not formed (hereinafter referred to as an uncoated layer). Because the coating layer 30 is formed to a preset thickness, a step having a height the same as the thickness of the coating layer 30 may exist at the interface defined by the coating layer 30 and the uncoated layer.

Referring to FIGS. 1 and 2, a plurality of application portions 110 may be arranged above the base material 10. The plurality of application portions 110 may each apply the electrode slurry on both surfaces of the base material 10. As such, the coating layer 30 may be formed on both surfaces of the base material 10.

Referring to FIG. 1, the drying portion 150 may include a heat source supplying heat to the base material 10 that has passed the application portion 110 and may cure the coating layer 30 by removing a solvent included in the coating layer 30 maintaining a certain shape of the coating layer 30.

A drying method of the drying portion 150 may include a hot wind drying method, in which a hot air blower is arranged in a drying furnace and supplies the hot wind, but the present disclosure is not limited thereto. as the drying method may include vacuum drying, infrared-ray drying, etc. to evaporate the solvent by drying the coating layer 30.

A plurality of drying portions 150 may be arranged above the base material 10. In an embodiment, when the coating layers 30 are formed on both surfaces of the base material 10, the plurality of drying portions 150 may respectively dry the coating layers 30 formed on both surfaces of the base material 10.

Referring to FIG. 2, the electrode sheet that has passed the coating portion 100 and has both surfaces being coated may include three regions. Region S1 includes both surfaces of the base material having the respective coating layers, region S2 includes both surfaces of the base material being uncoated layers, and region S3 includes the coating layer being formed on only one surface of the base material leaving the other surface being an uncoated layer.

Referring to FIG. 2, each region may have various thicknesses. Region S1 may have the greatest thickness among the three regions, region S3 may have next greatest thickness among the three regions, and region S2 may have a least thickness among the three regions.

In an embodiment, a difference between the thickness of region S1 and the region S2 may be equal to or greater than about two times the thickness of the coating layer 30.

Referring to FIGS. 1, 3 to 6, the attachment portion 200 attaches a tape 50 onto a region other than the coating layer 30 on the base material 10 and may include a sensor unit 210, an attachment body 230, and a controller 250.

Referring to FIG. 1, the sensor unit 210 may sense whether there exists the coating layer 30 along the longitudinal direction and may transmit position information and distance information of the uncoated layer to the controller 250.

The sensor unit 210 may include a sensor capable of distinguishing the coating layer 30 formed on the base material 10 from the uncoated layer while the base material 10 is being transported in the transport direction.

The sensor may include a laser sensor; however, the present disclosure not limited thereto. The sensor may include a charge coupled device (CCD) camera sensor, an ultrasound sensor, a temperature sensor, etc.

Referring to FIGS. 1 and 3, the attachment body 230 may attach the tape 50 onto the base material 10. In an embodiment, the attachment body 230 is controlled by the controller 250, and the attachment body 230 may attach the tape 50 onto the uncoated layer of the base material 10 that is transported in the transport direction.

The tape 50 may be supplied by the attachment body 230 and may be provided in a roll type before being attached to the uncoated layer.

In an embodiment, the uncoated layer of the base material 10 that is being transported in the transport direction passes one side of the attachment body 230 (e.g., the lower side in FIG. 1), where the wound roll may be unwound and the tape 50 may be attached to the uncoated layer.

In an embodiment, when the base material 10 is continuously transported and the coating layer 30 passes one side of the attachment body 230 (e.g., the lower side in FIG. 1), the attachment body 230 may stop supplying the tape 50.

Referring to FIGS. 4 to 6, the attachment body 230 may attach the tape 50 onto both surfaces of region S2 where both surfaces of the base material are uncoated layers, or may attached the tape 50 onto the uncoated layer of region S3 where the coating layer is only formed on one surface of the base material.

In an embodiment, the tape 50 may have a thickness that is 50% to 120% of the thickness of the coating layer 30. In an embodiment, the tape 50 may have a thickness that is 80% to 100% of the thickness of the coating layer 30. coating layer 30 any steps present between the coating layer 30 and the uncoated layer may be reduced via the application of the tape 50.

In an embodiment, the steps may be all removed via the application of the tape 50, and the total thickness of the base material 10 on which the coating layer 30 and the tape 50 are arranged may be evenly formed while having minimal undulations.

Referring to FIG. 6, the tape 50 may be attached to the uncoated layer on the base material 10 and may include an attachment layer 51 and a film layer 53.

The attachment layer 51 may be in contact with the base material 10 and may include an adhesive material that is attachable to the base material 10.

The adhesive material may include an acryl adhesive, a rubber adhesive, an epoxy adhesive, a polyurethane adhesive, a silicone adhesive, etc. In an embodiment, the tape 50 may be stably adhered to the uncoated layer.

Referring to FIG. 8, the attachment layer 51 may have a volume that may vary depending on temperature. In an embodiment, the attachment layer 51 may include expandable microspheres 51a that may expand as temperature increases.

The expandable microsphere 51a may include a shell forming an exterior of a capsule and may have a spherical shape.

The shell may have a hollow structure. The shell may have a diameter of about 5 μm to about 50 μm, and a thickness of about 2 μm to about 15 μm. The shell may include a thermosetting resin.

According to an embodiment of the present disclosure, liquid hydrocarbon may be accommodated within the shell. The liquid hydrocarbon may include propane, butane, pentane, hexane, octane, etc.

The liquid hydrocarbon is configured to expand in volume when heat is applied from the outside. When heat is applied to the expandable microsphere 51a, the volume of the shell may expand resulting in a foam.

Referring to FIGS. 4 to 6, the film layer 53 is connected to the outer surface of the attachment layer 51, opposite to the inner surface of the attachment layer 51 in contact with the base material 10. The outer surface of the film layer 53corresponds to the exterior surface of the tape 50. The film layer 53 may have high strength and durability. The tape 50 is adhered to the uncoated layer or the base material 10 and the film layer 53 may prevent the tape 50 from being torn off or being damaged.

The film layer 53 may include polyvinyl chloride (PVC), polyester (PET), polypropylene (PP), silicone, etc.

The film layer 53 may include a thermosetting resin. In an embodiment, the film layer 53 may include an epoxy resin, a polyester resin, a vinyl ester resin, or a phenol resin. In an embodiment, when heat is applied to the tape 50, the film layer 53 may be vaporized and therefore be removed.

Referring to FIG. 3, the controller 250 may receive from the sensor unit 210 information as to whether the coating layer 30 is present and control the the attachment body 230. In an embodiment, the controller 250 may receive position information of the uncoated layer and the coating layer 30 and control the attachment body 230 so as to attach the tape 50 to a precise position.

In an embodiment, when the uncoated layer is sensed by the sensor unit 210, the controller 250 may control the attachment body 230 to attach the tape 50 onto the uncoated layer. In an embodiment, when the coating layer is sensed, by the sensor unit 210, the controller 250 may stop the attachment body 230 from attaching the tape 50.

Referring to FIG. 1 and FIG. 7, the pressing portion 300 may press the coating layer 30 and the tape 50 disposed on the base material 10 and may include a plurality of pressing rollers 310a and 310b that may come into contact in the direction parallel to the surfaces of the base material 10.

The plurality of pressing rollers 310a and 310b may have substantially the same diameters and may be arranged on both sides of the base material 10.

The coating layer 30 and the tape 50 disposed on the base material 10 may be pressed and attached while passing between the plurality of pressing rollers 310a and 310b.

Referring to FIG. 7, a thickness t2 of the base material 10, the coating layer 30, and/or the tape 50 after passing the pressing portion 300 may be reduced in comparison with a thickness t1 of the base material 10, the coating layer 30, and/or the tape 50 before passing the pressing portion 300.

In an embodiment, the coating layer 30 may be spread in a thin manner while coming into close contact with the base material 10, and adhesion between the active material and the base material 10 may be improved, thereby maximizing the performance of the electrode. In some embodiments, the thickness of the coating layer 30 may be maintained evenly and electrical characteristics of the electrode may be maintained constant.

In some embodiments, the tape 50 attached to the uncoated layer may be also compressed when passing between the plurality of pressing rollers 310a and 310b.

In a conventional electrode sheet manufacturing apparatus, the base material 10 passes through the pressing portion while only the coating layer 30 is only formed on the base material 10 (that is, without a tape forming steps). Accordingly, greater pressure is applied to the steps between the coating layer 30 and the uncoated layer in comparison with other regions of the coating layer 30.

In the conventional electrode sheet manufacturing apparatus, both end portions of the coating layer 30 (where the steps are located) are compressed greater than other regions of the coating layer 30, resulting in an uneven thickness of the coating layer 30, degrading the quality of the electrode sheet.

In a conventional electrode sheet manufacturing apparatus, because a region comparable to region S3 of the present disclosure, where the coating layer is only formed on one surface of the base material, may have less thickness than a region comparable to region S1 of the present disclosure, where the coating layers are formed on both surfaces of the base material, it may be difficult to achieve a desired degree of rolling, resulting in inferior adhesive force and rolling rate of the coating layer 30.

In contrast, embodiments of the present disclosure provide an electrode sheet manufacturing apparatus 1 applying the tape 50 to compensate any thickness variation resulting from height differences between the coating layer 30 and the uncoated layer.

In an embodiment, quality degradation due to the uneven thickness of the coating layer 30 and degradation in the adhesive force and rolling rate of the coating layer 30 may be minimized. Accordingly, the coating layer 30 does not partially fall off during the battery manufacturing that may cause shorts.

Referring to FIG. 1 and FIG. 8, the removal portion 400 removes the tape 50 from the base material 10 and may include a heater housing 410 and heater bodies 430.

The heater housing 410 may have a hollow structure allowing the base material 10 to which the tape 50 is attached to pass through. In an embodiment, the tape 50 may be removed while the base material 10 passes through the heater housing 410.

The heater body 430 may be positioned in the heater housing 410 to supply heat to the tape 50 passing through the heater housing 410. In an embodiment, the heater body 430 may include a device capable of supplying heat to one surface of the base material 10.

The heater body 430 may include an electrical heater, a gas heater, a steam heater, or a fan circulating heated air, but the present disclosure is not limited thereto. The heater body 430 may include any device capable of supplying heat to the tape 50 attached to the base material 10.

The heater body 430 may provide a temperature of about 100° C. to about 200° C. or about 130° C. to about 160° C.

Referring to FIG. 6 and FIG. 8, when the heater body 430 supplies heat to the tape 50, the attachment layer 51 may expand. In an embodiment, the expandable microspheres 51a included in the attachment layer 51 including the expandable liquid hydrocarbon may expand and form bubbles in the attachment layer 51 when the temperature rises.

In an embodiment, the tape 50 may be removed from the uncoated layer, and the film layer 53 including the thermosetting resin may be also vaporized and/or removed due to heat supplied by the heater body 430.

In an embodiment, the tape 50 may be separated from the base material 10 simply by supplying heat to the tape 50 without using an additional device.

In an embodiment, the expandable microsphere 51a that expands when the heat is applied thereto is included in the attachment layer 51, and thus, the tape 50 may be separated neatly from the base material 10 without leaving residue on the uncoated layer during the separation process and/or being attached to another region of the base material 10.

Referring to FIG. 1 and FIG. 8, the heater housing 410 may have a hollow structure and may have an inlet portion 411, in which the base material 10 is introduced, in one side thereof and an outlet portion 415, where the base material 10 enters into.

In an embodiment, when the base material 10 is introduced through the inlet portion 411, the heater body 430 may start heating the tape 50 and isolate the tape 50 from the base material 10. In an embodiment, the base material 10, having the tape 50 detached from the base material 10, may be discharged through the outlet portion 415 with the uncoated layer exposed.

Referring to FIG. 1 and FIG. 8, the removal portion 400 may include rollers 450 that may come into contact with the base material 10 and may transport the base material 10 in the transport. A plurality of passing rollers 450 may be provided in the heater housing 410.

According to an embodiment of the present disclosure, the movement of the base material 10 in the heater housing 410 may be carried out by the passing rollers 450 that rotationally move while coming into contact with one or more surfaces of the base material 10. As such, the tape 50 may be isolated from the base material 10 while the base material 10 moves in the transport direction.

Referring to FIG. 1, the transport portion 500 is configured to transport the base material 10 along a preset direction and may transport the base material 10 in the transport direction while constantly maintaining the tension of the base material 10.

The transport portion 500 may include a transport roller 510 that may come into contact with one or more surfaces of the base material 10 and may be rotatable. A plurality of transport rollers 510 may be provided in the electrode sheet manufacturing apparatus 1 and may be arranged between the components so as to contact and support the base material 10 and at the same time, transport the base material 10 in the transport direction.

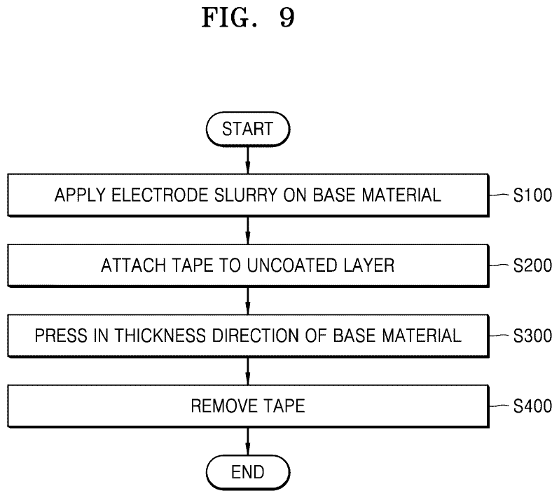

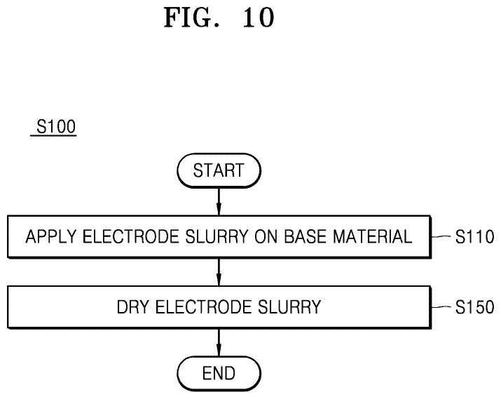

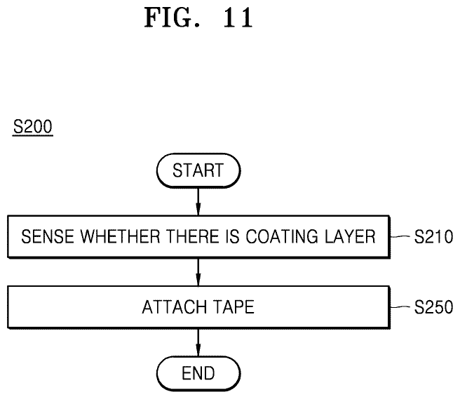

FIG. 9 is a flowchart showing a method of manufacturing an electrode sheet according to embodiments of the present disclosure. FIG. 10 is a flowchart showingcertain processes in FIG. 9 in detail according to embodiments of the present disclosure. FIG. 11 is a flowchart showing certain processes of FIG. 9 in detail according to embodiments of the present disclosure.

Referring to FIG. 9, the electrode sheet manufacturing method may include a process of applying an electrode slurry and forming a coating layer (S100), a process of attaching a tape on a region of a base material other than regions where the coating layer is applied (S200), a process of pressing the coating layer and the tape (S300), and a process of removing the tape from the base material (S400).

Referring to FIG. 10, the process of applying the electrode slurry and forming the coating layer on the base material (S100) may include a process of applying the electrode slurry on a preset region on the base material (S110), and a process of drying the applied electrode slurry (S150).

Referring to FIGS. 1 and 10, the process of applying the electrode slurry on the preset region of the base material (S110) may be carried out by the application portion 110. The application portion 110 may apply the electrode slurry in which an active material, a binder, a conductor, a solvent, etc. are mixed and applied on the base material 10 to reach a uniform thickness.

In an embodiment, the base material 10 that is unwound from the unwinding portion UR and supplied may be transported in the transport direction by the plurality of transport rollers 510 provided in the electrode sheet manufacturing apparatus 1. The application portion 110 may be arranged above one surface of the base material 10 and may be spaced apart a preset distance from the base material 10.

The application portion 110 may apply the electrode slurry on the base material 10 to form the coating layer 30 coming into contact with a preset region of the base material 10. The application portion 110 may form the coating layer 30 so that the region on which the electrode slurry is applied and the region on which the electrode slurry is not applied alternately appear, and accordingly, the coating layer 30 may be formed on the base material 10 in a certain pattern.

Referring to FIG. 2, due to the coating layer 30 applied by the application portion 110, a step as high as the thickness of the coating layer 30 may be formed between the coating layer 30 and the uncoated layer.

Referring to FIGS. 1 and 10, the process of drying the applied electrode slurry (S150) may be carried out by the drying portion 150 and may include the process in which the coating layer 30 formed on the base material 10 is dried so as to evaporate the solvent included in the electrode slurry.

In an embodiment, the shape of the coating layer 30 may be uniform and the thickness of the coating layer 30 may be constantly maintained.

The process of applying the electrode slurry (S110) may include a process in which both surfaces of the base material 10 are sequentially coated by the plurality of coating portions 100. In an embodiment, the application portion 110 may apply the electrode slurry on one surface of the base material 10 and dry the electrode slurry by using the drying portion 150, and then, may apply the electrode slurry on the other surface of the base material 10.

In an embodiment, the coating layer 30 applied on the other surface of the base material 10 may be dried by using the drying portion 150.

Referring to FIG. 2, the coating layers 30 may be formed in preset patterns on both surfaces of the base material 10. The base material 10 may include region S1 where the coating layers are formed on both surfaces, region S2 where both surfaces are uncoated layers, and/or region S3 where the coating layer is formed only on one surface.

Referring to FIG. 11, the process of attaching the tape to a region of the base material, other than the coating layer, (S200) may include a process of sensing whether there is the coating layer on the base material (S210), and a process of attaching the tape on the region where the coating layer is not formed (S250), performed by the attachment portion 200.

In an embodiment, referring to FIGS. 1, 3 to 6, and 11, the process of sensing whether there is the coating layer on the base material (S210) may be carried out by the sensor unit 210.

The sensor unit 210 may include a sensor that may distinguish the coating layer 30 from the uncoated layer on the base material 10 that is transported in the transport direction. The sensor included in the sensor unit 210 may be a laser sensor, but is not limited thereto, and may include a CCD camera sensor, an ultrasound sensor, a temperature sensor, etc.

The sensor unit 210 may sense the position of the coating layer 30 and the uncoated layer and may transmit sensing data to the controller 250.

The controller 250 receives the positions of the coating layer 30 and the uncoated layer from the sensor unit 210 and drives the attachment body 230 when the uncoated layer arrives at a precise position where the attachment body 230 starts, by calculating a distance from the base material 10 and the attachment body 230 and a velocity of the base material 10.

In an embodiment, the attachment portion 200 may attach the tape 50 precisely to the uncoated layer of the base material 10.

Referring to FIGS. 1 to 3 and 11, the process of attaching the tape to the region where the coating layer is not formed (S250) may be carried out by the attachment body 230.

The attachment body 230 may include a supply unit including the tape 50 wound in a roll type and may be driven by the controller 250 to attach the tape 50 to the uncoated layer. The attachment portion 200 may be fixedly installed on a preset region on the electrode sheet manufacturing apparatus 1, and the base material 10 may be disposed on one side (e.g., lower side in FIG. 1) of the attachment portion 200 and may be moved in the transport direction (e.g., right hand side in FIG. 1) set in advance.

As the base material 10 moves in the transport direction, the region where the coating layer 30 is formed passes one side of the attachment body 230 (e.g., lower side in FIG. 1), and the attachment body 230 may stop supplying the tape 50 onto the base material 10.

When the uncoated layer passes through one side of the attachment body 230, the attachment body 230 operates due to a signal received by the controller 250, and the rolled tape 50 may be unwound by the length of the uncoated layer and attached to the uncoated layer.

When the base material 10 moves again in the transport direction and the coating layer 30 passes through one side of the attachment body 230, the attachment body 230 may stop supplying the tape 50 to the base material 10.

Referring to FIGS. 4 to 6 and 11, the process of attaching the tape to the region other than the coating layer on the base material (S200) may be performed on either or both surfaces of the base material 10. In an embodiment, the tape 50 may not be attached to region S1 where the coating layers are formed on both surfaces of the base material.

In an embodiment, the tape 50 may be attached to both surfaces of region S2 where both surfaces of the base material are uncoated layers, and in region S3, the tape 50 may be attached to only one surface of the base material 10 where the uncoated layer is formed.

Referring to FIG. 6, the tape 50 may include the attachment layer 51 that is arranged facing the base material 10 and comes into contact with the base material 10, and the film layer connected to one surface of the attachment layer 51.

According to an embodiment of the present disclosure, the tape 50 may have a thickness of about 50% to about 120% the thickness of the coating layer 30 or about 80% to about 100% the thickness of the coating layer 30. In an embodiment, the step generated between the uncoated layer and the coating layer 30 may be minimized when the tape 50 is attached to the uncoated layer.

The attachment layer 51 may include an adhesive material including an acryl adhesive, a rubber adhesive, an epoxy adhesive, etc. Expandable microspheres can be disposed in the adhesive material and may expand in volume according to temperature.

The expandable may include a shell forming an exterior of a capsule having a spherical shape, and liquid hydrocarbon can be disposed in the hollow cavity formed by the shell.

In some embodiments, the film layer may include a thermosetting resin. In an embodiment, the thermosetting resin may include a phenol resin, epoxy resin, polyester resin, etc.

Referring to FIGS. 1, 7, and 9, the process of pressing the coating layer and the tape (S300) may include a process of improving a bonding force between the base material 10 and the active material by making the coating layer 30 thin and flat due to an external force and come into close contact with the base material 10.

The process of pressing the coating layer and the tape (S300) may include a process of providing external force in the direction parallel to the surfaces of the base material 10 to press the coating layer 30 and the tape 50 disposed on the base material 10.

Referring to FIGS. 1 and 7, the process of pressing the coating layer and the tape (S300) may be carried out by the pressing portion 300. In an embodiment, the base material 10 having the coating layer 30 and/or the tape 50 may pass through the plurality of pressing rollers 310a and 310b that are arranged in the direction parallel to the surfaces of the base material 10.

The plurality of pressing rollers 310a and 310b may be arranged at both sides (e.g., upper and lower sides in FIG. 7) of the base material and may rotate to press the base material 10 that moves along the transport direction (e.g., right hand side in FIG. 7) to press the coating layer 30 and the tape 50 disposed on both surfaces of the base material 10. In some embodiments, the plurality of pressing rollers 310a and 310b may have substantially the same diameter.

In an embodiment, a density of the electrode may be improved, and a bonding force between the base material 10 and the active material may be improved, thereby improving the overall performance of the battery.

Referring to FIG. 7, the thickness t2 of the base material 10, the coating layer 30, and the tape 50 after passing through the pressurizing portion 300 may be less than the thickness t1 of the base material 10, the coating layer 30, and the tape 50 before passing through the pressurizing portion 300.

Aas shown in FIG. 2, when the pressing process is performed while the tape 50 is not attached to the uncoated layer, more pressure may be applied to the end portions of the coating layer 30 (corresponding to the steps) than other regions of the coating layer 30.

In an embodiment, the thickness of both ends of the coating layer 30 may be formed relatively thinner than other regions of the coating layer 30. The thickness of the coating layer 30 may not be uniform, which may cause incorrect wounding of the electrode sheet.

In an embodiment, region S3 where the coating layer is formed only on one surface of the base material may have a thickness less than that of region S1 where the coating layers are formed on both surfaces of the base material, and thus may not be appropriately applied with the pressure during the pressing process, causing degradation in bonding force and rolling rate of the coating layer 30 with respect to the base material 10.

In an embodiment, the tape 50 may reduce the step generated due to the coating layer 30 located adjacent to the uncoated layer before the pressing process. The pressing rollers 310 may evenly apply the pressure onto the base material 10 on which the coating layer 30 and the tape 50 are disposed.

In an embodiment, the uneven thickness of the coating layer 30 and the degradation in the bonding force and the rolling rate of the coating layer 30 may be addressed, and the quality of the electrode sheet may be improved.

Referring to FIGS. 1, 8, and 9, the process of removing the tape (S400) may be carried out by the removal portion 400 and may include a process in which the heat source is supplied to the tape 50 to isolate the tape 50 from the base material 10.

Referring to FIG. 8, the coating layer 30, the tape 50, and the base material 10 pressed by the pressing portion 300 may be introduced into the heater housing 410 through the inlet portion 411. Here, the heater body 430 installed in the heater housing 410 may supply heat to the tape 50 that is transported along the transport direction.

A plurality of heater bodies 430 may be provided, and the plurality of heater bodies 430 may be arranged to respectively face one surface of the base material 10. The temperature of the heat supplied by the heater body 430 may be about 100° C. to about 200° C. or about 130° C. to about 160° C.

Referring to FIG. 8, the expandable microspheres included in the attachment layer 51 may expand due to the heat supplied by the heater body 430, and as the volume of the expandable microsphere expands, bubbles may be formed in the attachment layer 51 and the attachment layer 51 may be isolated from the base material 10.

The film layer including the thermosetting resin may be vaporized due to the heat supplied by the heater body 430 and may be removed from the base material 10.

In an embodiment, the tape 50 may be easily isolated from the base material 10 only by supplying heat without using a supplemental device.

The expandable microspheres can be included in the attachment layer 51. The tape 50 may be separated neatly from the base material 10 without leaving remains on the uncoated layer during the separation process and withing being attached to another region of the base material 10.

Referring to FIG. 8, the movement of the base material 10 in the heater housing 410 may be carried out by the passing rollers 450 that rotationally move while coming into contact with one surface of the base material 10. In an embodiment, the tape 50 may be isolated from the base material 10 while the base material 10 moves in the transport direction.

In some embodiments, the base material 10 from which the tape 50 is isolated and the uncoated layer is exposed may be discharged out of the removal portion 400 through the outlet portion 415 place one one side of the heater housing 410.

The electrode sheet manufacturing method may further include a process of cutting the base material 10 at preset intervals along the lengthwise direction (not shown in the drawings).

In an embodiment, the process of cutting the base material 10 may include a process of cutting the width of the base material 10 on which the coating layer 30 is formed, to a suitable size of a battery case in which the electrode sheet is to be accommodated.

The electrode sheet manufacturing apparatus may improve the quality of the electrode sheet, due to the application of uniform pressure to the entire region of the coating layer and the uncoated layer having the tape.

In some embodiments, by attaching the tape to the uncoated layer in the region where the coating layer is formed only on one surface of the base material, degradation in the bonding force and the rolling rate may be prevented due to the coating layer being applied with relatively less pressure during the pressing process.

In some embodiments, by attaching the tape including the expandable microsphere to the uncoated layer, the tape may be easily isolated from the base material only by supplying heat without using an additional removing device.

Although the present disclosure has been described above with respect to embodiments thereof, the present disclosure is not limited thereto. Various modifications and variations can be made thereto by those skilled in the art within the spirit of the present disclosure.

What is claimed is:

1. An electrode sheet manufacturing apparatus comprising:
a coating portion configured to apply an electrode slurry on a base material to form a coating layer;
an attachment portion downstream of the coating portion, the attachment portion configured to attach a tape to the base material in a region where the coating layer is not formed;
a pressing portion downstream of the attachment portion, the pressing portion configured to press the coating layer and/or the tape; and
a removal portion downstream of the pressing portion, the removal portion configured to remove the tape from the base material.

2. The electrode sheet manufacturing apparatus of claim 1, further comprising a transport portion transporting the base material in a preset direction.

3. The electrode sheet manufacturing apparatus of claim 1, wherein the coating portion comprises:
an application portion spaced apart from the base material and configured to apply the electrode slurry; and
a drying portion downstream of the application portion configured to supply heat to the base material.

4. The electrode sheet manufacturing apparatus of claim 1, wherein the attachment portion comprises:
an attachment body attaching the tape to the base material;
a sensor unit configured to sense presence of the coating layer; and
a controller configured to receive information from the sensor unit and configured to control the attachment body.

5. The electrode sheet manufacturing apparatus of claim 1, wherein the tape comprises:
an attachment layer configured to be attached to the base material; and
a film layer in contact with the attachment layer.

6. The electrode sheet manufacturing apparatus of claim 5, wherein the attachment layer is expandable based on temperature.

7. The electrode sheet manufacturing apparatus of claim 5, wherein the film layer comprises a thermosetting resin.

8. The electrode sheet manufacturing apparatus of claim 1, wherein the pressing portion comprises a pressing roller configured to press the base material in a direction parallel to a surface of the base material.

9. The electrode sheet manufacturing apparatus of claim 1, wherein the removal portion comprises:
a heater housing configured to pass through the base material; and
a heater body positioned in the heater housing and configured to supply heat to the tape.

10. The electrode sheet manufacturing apparatus of claim 9, wherein the heater housing has a hollow structure and has an inlet portion and an outlet portion.

11. A method for manufacturing an electrode sheet, comprising:
applying an electrode slurry on a base material to form a coating layer;
attaching a tape to the base material in a region where the coating layer is not formed;
pressing the coating layer and/or the tape; and
removing the tape from the base material.

12. The method of claim 11, wherein the applying comprises:
applying the electrode slurry on a preset region of the base material; and
drying the electrode slurry.

13. The method of claim 11, wherein the attaching comprises:
sensing presence of the coating layer; and
attaching the tape to the region where the coating layer is not formed.

14. The method of claim 11, wherein a thickness of the tape is 50% to 120% of a thickness of the coating layer.

15. The method of claim 11, wherein the tape comprises:
an attachment layer configured to be attached to the base material; and
a film layer in contact with the attachment layer.

16. The method of claim 15, wherein the attachment layer is expandable based on temperature.

17. The method of claim 15, wherein the film layer comprises a thermosetting resin.

18. The method of claim 11, wherein the pressing comprises:
pressing the base material in a direction parallel to a surface of the base material.

19. The method of claim 11, wherein the removing comprises applying heat to the tape.

20. The method of claim 11, further comprising cutting the base material at preset intervals along a longitudinal direction.
